(19) United States
(12) Patent Application Publication
(10) Pub. No.: US 2006/0034962 A1
(43) Pub. Date: Feb. 16, 2006

(54) Device for extruding thermoplasts

(75) Inventors: Norbert Guntherberg, Nachtigallenweg (DE); Bernhard Czauderna, Nachtigallenweg (DE); Michael Sauer, Hardtstr.9 (DE); Rainer Bardon, Deidesheimer (DE); YoHwan An, Nam Ku (DE)

Correspondence Address: CONNOLLY BOVE LODGE & HUTZ, LLP, P O BOX 2207, WILMINGTON, DE, 19899, US

(73) Assignee: BASF AKTIENGESELLSCHAFT, Ludwigshafen (DE)

(21) Appl. No.: 10/527,929

(22) PCT Filed: Sep. 8, 2003
(86) PCT No.: PCT/EP03/09941

§ 371 Date: Mar. 16, 2005

(30) Foreign Application Priority Data
Sep. 20, 2002 (EP) 02021020.9

(51) Int. Cl. B29C 47/36

(52) U.S. Cl. 425/208

(57) ABSTRACT

An apparatus intended for extruding thermoplastics and having at least one devolatilization orifice and, if desired, also at least one dewatering orifice, which has been equipped with a metal-wire-mesh composite sheet, with a finely perforated metal sheet, or with a slit diaphragm.

The present invention relates to an apparatus intended for extruding thermoplastics and encompassing at least one devolatilization orifice. The invention further relates to a process for preparing thermoplastics in an extruder with mechanical dewatering. The present invention further relates to the use of the apparatus for preparing toughened thermoplastics or polymer blends which comprise toughened thermoplastics. Other preferred embodiments are found in the claims and the description.

The devolatilization and dewatering of thermoplastics by means of extruders is known:

For example, JP-A 2-286208 discloses three different dewatering methods using an extruder which has two screws. In each case, moisture in liquid form and also in the form of gas is removed from the extrusion material by way of Seiher housings.

In JP-A 57167303, extrusion product (in this case slurries of polymer particles, for example) is metered into a twin-screw extruder, dewatered, devolatilized, and kneaded. Upstream of the transition zone, water can be discharged from the extruder in liquid form. Residual moisture can escape in the form of gas. Seiher housings are used as dewatering orifices.

JP-A 60222223 discloses a process in which water in liquid form is removed from extrusion product (preferably food but also other materials). The dewatering takes place by means of a twin-screw extruder. The moisture is discharged backward through an orifice which has, if desired, a connection to a vacuum pump.

WO 98/13412 describes extruders which have at least one squeeze section with at least one retarding element and with an associated dewatering orifice upstream prior to the first retarding element. The extruders also comprise devolatilization sections located after the final plastication section. The devolatilization orifices and dewatering orifices may have an apparatus hindering the discharge of extrusion product. Retaining screws are described as preferred for this purpose. It is also said that Seiher housings or screens are not suitable for the covering of dewatering orifices, since Seiher housings become blocked too rapidly. Screens have the further disadvantage of mechanical instability. According to WO 98/13412, devolatilization orifices are preferably not provided with any cover.

It has been known that screens or filters can be used in extrusion apparatus to remove contamination from the melt:

For example, U.S. Pat. No. 5,055,244, EP-A1 229 346 or EP-A2 728 510 disclose that extrusion material can be pressed through a filter prior to injection molding in order to remove contamination. DE-A1 23 122 moreover discloses that an extrusion orifice covered by a reinforced screen permeable to 40μ can be used to produce extremely thin filaments.

DE-A1 42 37 174 describes an injection molding machine for the devolatilization of hygroscopic injection materials. The screw runs in a cylinder whose wall has a multilayer structure. The inner wall is composed of a sintered metal. This is permeable to water vapor. The vapor which has passed through the sintered metal is transported away via channels located in the cylinder wall. An outer wall forms a sheath surrounding the cylinder.

CH 512 979 discloses an extrusion apparatus intended for plastics and also capable of use for dewatering the materials to be treated. It is based on a similar principle. The barrel has a lining of sintered metal. This may be composed of rings of sintered metal arranged in series. Each of these sintered metal rings has an external annular channel which can be evacuated in order to transport away the gas that has passed through the sintered ring. A disadvantage of this design is its complicated nature.

Retaining screws are very effective in hindering the discharge of the extrusion material through the devolatilization orifices or dewatering orifices, but require high capital expenditure. Since they are moving parts, they require regular maintenance. In addition, they are not completely effective in retaining very finely divided particles of product.

Seiher housings have areas composed of laminates intended to retain the extrusion material but to permit passage of the water vapor or the water through long narrow slits of width generally from 0.1 to 1 mm. Although they retain the extrusion material, they permit the passage of an undesirably high proportion of fine particles of solid, or readily become blocked thereby and therefore require frequent cleaning. In addition, fine particles which have escaped have to be regularly and carefully removed, since very fine particles pose a fire risk.

The manufacture of the inner barrel of extrusion machines from a permeable material, either throughout or in the form of sintered rings, is firstly complicated in a technical sense. Secondly, the machines have to be completely shut down for cleaning, and the screws removed, and the machine further dismantled. Technical designs of this type are also frequently inadequate to withstand the pressures arising in the apparatus.

As can be seen from the prior art, devolatilization orifices or dewatering orifices have preferably not been covered with conventional screens, since these block relatively rapidly and are inadequate to withstand the mechanical loads.

It is an object of the present invention, therefore, to provide an apparatus of the abovementioned type which does not have the disadvantages mentioned. In particular, the intention was to find an apparatus which causes less than 1 g of fine particles to be discharged via the gases emerging through the devolatilization orifices per kg of extrusion material conducted past the relevant orifice. A further object is that the apparatus intended to hinder the discharge of extrusion material from the devolatilization orifices should have high mechanical strength, be easy to clean, and require minimum capital expenditure.

We have found that this object is achieved by means of an apparatus intended for the extrusion of thermoplastics and encompassing at least one devolatilization orifice, in which the devolatilization orifice has been equipped with a metal-wire-mesh composite sheet (“MCS”), with a finely perforated metal sheet, or with a slit diaphragm.

Thermoplastics which may be used are any of the high-molecular-weight or oligomeric compounds which become soft when the temperature is increased once their glass transition temperature has been exceeded. These may include plastics, natural products, or pharmaceutical products. Thermoplastics are known to the skilled worker. We will therefore mention here by way of example only polyamides, polycarbonates, styrene polymers and derivatives, copolymers or mixtures of these polymers. Examples of styrene copolymers are styrene-acrylonitrile copolymers, also often termed SAN polymers, rubber-modified styrene copolymers, such as acrylonitrile-butadiene-styrene copolymers, often also termed ABS, acrylonitrile-acrylate-styrene copolymers, often also termed ASA. Besides these, use may also be made of derivatives or variants of SAN polymers, ABS, or ASA, for example those based on alpha-methyl styrene or methacrylate, or those which encompass other comonomers, for example the material known as MABS. It is, of course, also possible to use mixtures of two or more different styrene copolymers. Use may also be made of rubber-modified styrene copolymers based entirely or partially on other rubbers, for example on ethylene-butadiene rubbers or on silicone rubbers. Preference is also given to mixtures of the polymers mentioned with polyamides, with polybutylene terephthalates, and/or with polycarbonates. Other thermoplastics are listed in detail below.

A suitable apparatus of the invention is per se any extruder which encompasses at least one devolatilization orifice and is capable of extruding thermoplastics. This also includes extruders which are used in processes such as injection molding. Extruders are known per se, and reference may therefore be made to the generally available literature. For example, use may be made of extruders as disclosed in the abovementioned documents. Extruders generally encompass at least one metering section, at least one plastication section, and a discharge zone.

The number, arrangement, and design of the devolatilization orifices generally depends on the amount of the gas which is intended to escape from the extruder. For example, the number, arrangement, and geometry of the devolatilization orifices used in extruding water-containing thermoplastics depends on the water content of the thermoplastic and on the desired residual water content of the final product.

According to the invention, the extruders have at least one devolatilization orifice. However, they may also have two or more devolatilization orifices. For example, they may encompass two or three devolatilization orifices. However, it is also possible for the extruders to have very many more devolatilization orifices, for example up to 30.

The location of the devolatilization orifices may be on the upper side of the barrel of the extruder. However, their arrangement may also be lateral or downward-facing. It is also possible, for example, for the arrangement of the devolatilization orifices to be lateral in opposing pairs or facing upward and downward in opposing pairs. A combination of the arrangements mentioned may also be used. For example, the arrangement of each devolatilization orifice may be alongside another devolatilization orifice or above another devolatilization orifice. However, another possible arrangement has two or more devolatilization orifices situated alongside one another or above one another.

The number and the position of the devolatilization orifices depends on the particular objects to be achieved.

Devolatilization generally takes place downstream of the metering zone in the conveying direction, or downstream of the metering zone and the homogenizing zone, i.e. in a forward direction. However, the devolatilization may also take place upstream in a direction opposite to the conveying direction, i.e. in a backward direction with respect to the metering zone. In the simplest case there is only one devolatilization orifice, the arrangement of which may be upstream or downstream of a metering zone. If there are two or more metering zones, the devolatilization may take place upstream or downstream with respect to each of these metering zones.

The design of the devolatilization orifices may be known per se, and their geometry may correspond to known orifices, for example those usually used to remove gaseous substances from an extruder. For example, use may be made of devolatilization orifices which are cutouts and/or holes in the extruder barrel. Examples of suitable devolatilization orifices are circular holes or holes in the shape of a horizontal figure of eight (i.e. two directly adjacent circular holes), a possible arrangement of the longitudinal axis of this horizontal figure of eight being at right angles (perpendicular to) or parallel (aligned with) the conveying direction of the extruder, for example. Another preferred design of the devolatilization orifices is rectangular, square, or oval, lateral, apical, or basal. The design of these square or rectangular orifices may have rounded corners. If use is made of more than one devolatilization orifice, it is also possible for these to have different geometries. The arrangement of the rectangular or oval devolatilization orifices is particularly preferably such that their longer side is parallel to the axis of the extruder. If the location of the devolatilization orifices is apical or basal, one embodiment of the orifices extends across all of the screws, for example across both screws of a twin-screw machine, so that both screws would be visible. However, complete or partial covering of one of the screws is also possible, so that only one side is devolatilized. As an alternative, the arrangement of the devolatilization orifice may be such that it does not have a tight fit, thus permitting devolatilization from all of the screws but dissipation of the gas only by way of the uncovered screw. If the pressure conditions permit, the arrangement of the devolatilization orifice may also involve the entire circumference of a cylinder.

According to the invention, the devolatilization orifice has been equipped with a metal-wire-mesh composite sheet (“MCS”), with a finely perforated metal sheet, or with a slit diaphragm. Among these, particular preference is given to the MCS.

If the apparatus has more than one devolatilization orifice, at least one has this provision. In one embodiment, all of the devolatilization orifices have this provision. In another preferred embodiment, some of the devolatilization orifices have this provision and the remaining devolatilization orifices are either open or have been provided with other apparatus which hinders the discharge of the material being conveyed. An example of this apparatus is a retaining screw. For example, each of the devolatilization orifices where the gas discharge velocity is greatest may have been provided with an MCS, with a finely perforated metal sheet, or with a slit diaphragm, while the devolatilization orifice(s) where little of the material being conveyed is discharged may be open. It can also be advantageous for those devolatilization orifices where the process can generate high pressures to have been provided with an MCS, with a finely perforated metal sheet, or with a slit diaphragm, there being a pressure retainer on the exit side of each of these apparatuses.

The MCS, the finely perforated metal sheet, or the slit diaphragm preferably has its geometry matched to that of the devolatilization orifice. For example, it may be circular, have the shape of a horizontal figure of eight, or be rectangular, square, or oval.

There is a very wide variety of methods for securing the MCS, the finely perforated metal sheet, or the slit diaphragm within the devolatilization orifice. It is preferable for each of the apparatuses described to be inserted, by welding or by soldering or under pressure, into a stable frame. The frame may then be inserted by clamping, or under pressure, or by screwing, into appropriate cutouts of a cramp within the devolatilization orifice. Attachment by a hinge is also possible, and here one side of the frame has been equipped with a securely attached hinge or comparable apparatus. A variable attachment, for example permitting the use of a hinge, permitting insertion under pressure, permitting screw attachment, click-in attachment, or attachment by means of a quarter-turn fastener has the advantage that appropriately prefabricated frames can be interchanged rapidly. This makes cleaning, maintenance, or inspection easier, and also makes it easier to adapt a machine as required by product changeover, for example.

The manner of attachment of the MCS, the finely perforated metal sheet, or the slit diaphragm within the devolatilization orifice may be such that the surface of the apparatus forms a level surface with the inner wall of the extruder barrel. The amount to which the surface of the MCS, finely perforated metal sheet, or slit diaphragm protrudes is generally not more than the gap between screw and wall in the extruder interior. This prevents damage either to the screw or to the MCS, the finely perforated metal sheet, or the slit diaphragm. Another advantage of this type of design is that it prevents formation of deposits on the MCS, on the finely perforated metal sheet, or on the slit diaphragm, or continual adhesion of extrusion material.

In another embodiment it can be advantageous to attach the MCS, the finely perforated metal sheet, or the slit diaphragm with a degree of recessing away from the screw. This avoids any mechanical contact between screw and MCS, finely perforated metal sheet, or slit diaphragm. However, with this type of attachment it can be necessary to ensure that no deposits of residues of extrusion material form in the dead spaces present. Recessed attachment can be particularly advantageous when the location of the devolatilization orifice is apical, in particular in the metering region, and pulverulent extrusion material is present. Provision of some degree of space for this material during devolatilization permits it to fall back into the screw flight.

If the surface of the MCS, of the finely perforated metal sheet, or of the slit diaphragm forms a level surface with the inner side of the extruder barrel, it preferably has the same curvature as the extruder barrel. However, it is also possible for the surface of the MCS, of the finely perforated metal sheet, or of the slit diaphragm to have any other curvature. For example, it can be advantageous for the surface to have a concave or convex curvature, or to be entirely flat. In one particularly preferred embodiment, its curvature corresponds to that of the screw, thus permitting the screw to follow the curvature of the surface and remove material from the same at regular intervals. If the position of the dewatering orifice is in the interstice between two screws it can be advantageous or necessary, for example, to adapt the shape of the surface so that it corresponds to a longitudinally sectioned figure of eight.

The MCS may be a wire mesh which is, for example, smooth or is of plain-woven structure. The wire mesh may have a square mesh shape or have a twill-weave structure. However, it may also be a smooth- or plain-woven braid mesh, or a twilled braid or reinforced braid. Wire meshes with a multilayer structure made from two, three or more plies, for example up to 30 plies, preferably from 2 to 10 plies, have very good mechanical stability and are therefore preferred. Preference is given here to MCSs which have a coarsely woven backing layer which has a coarse mesh but is mechanically stable (support mesh), on which there is a structure of intermediate layers and filter layers of increasingly narrow mesh and with increasingly fine-woven structure. For most applications it is preferable for the location of the finest mesh to be on the side facing toward the product. Examples of the mesh widths for this finest mesh may be from 1 μm to 500 μm. The mesh widths of the backing layer are generally markedly greater than that, and may be up to a few millimeters. Smaller mesh widths for the finest mesh are also possible, for example if the intention is to retain particularly fine particles. The nature of the mesh may be identical for all of the plies. However, it is also possible for the nature of the mesh to be identical for some of the plies and then to change, or to change from ply to ply. The nature of the mesh and the number of the plies depend on the particular object, in particular on the mechanical strength needed, on the pressure conditions, or on the separation requirements. In order to increase the mechanical strength of the MCSs, the individual wire meshes may have been sintered to one another. This embodiment is preferred. MCSs are known per se and are available commercially, for example for melt filtration purposes or as bases to accept the flow in fluidized-bed reactors. However, they may also be manufactured from parts known per se.

The finely perforated sheets which can be used according to the invention are finely perforated metal sheets with perforation widths of from 0.06 to 4 mm, for example. They may also have been combined with a wire mesh of the abovementioned type, the finely perforated metal sheet generally serving as backing material and the wire mesh as filter material. However, the opposite is also possible: a coarse wire mesh used as backing and a very finely perforated metal sheet used as filter layer. Finely perforated sheets are known per se and used in the prior art for screening centrifuges and other centrifuges.

Slit diaphragms which may be used according to the invention have orifices in the form of slits and differ from Seiher housings in particular in not having any continuous slits but having a large number of discrete orifices. The arrangement of these orifices may in principle be at any angle to the screw axis, for example parallel to the axis of the screw. However, the orifices may also run in some other direction with respect to the axis of the screw(s). In one of the preferred embodiments, the orifices of the slit diaphragm run perpendicularly to the axis of the screw, and in particular they run in a direction at 90° to the axis of the screw(s). The size of the orifices may be uniform. However, their size may also vary. The ratio of the length of the longer and shorter axes of the orifices may be in the range from 60:1 to 2:1, for example, preferably from 50:1 to 4:1. The shorter of the axes of the orifices may have a length of from 0.05 to 0.1 mm, for example, preferably from 0.05 to 0.09 mm. The shorter of the axes of the orifices may also be longer in the case of multi-ply slit diaphragms, for example up to 0.5 mm in length, and slit diaphragms with these larger orifices preferably have the ply or the plies with the larger orifices on the side facing away from the material being conveyed. Slit diaphragms of this type are known per se and are used in the prior art in screening centrifuges, other centrifuges, and fluidized-bed dryers.

The materials used to manufacture MCSs, finely perforated metal sheets, or slit diaphragms depend on the intended use. They are generally zinc- or tin-coated non-alloy steels, NiC(-carbon) steels, Cr steels, stainless steels, such as martensitic or austenitic steels of materials groups 1.43 (CrNi steels) or 1.44 (CrNiMo steels). However, use may also be made of high-temperature-resistant steels, or steels derived from alloys with copper, with nickel, with titanium, or with aluminum. For extrusion of natural substances for the food sector, or for extrusion in the drug sector, it can be necessary to use noble metals, such as silver. It is also possible to use polished, in particular smooth to mirror-finish metallic materials. Metallic surfaces which have what is known as the lotus effect may also be used. For exceptional cases in the low-temperature sector it is also possible to use plastics. Material groups 1.40 to 1.45 can cover most applications, and among these it is the chromium-nickel-molybdenum steels which are most frequently used.

The use of MCS sheet, finely perforated metal, or slit diaphragm is very effective in retaining fine solid particles, the result being that substantially the only material which escapes is gas, e.g. water vapor.

The MCS, the finely perforated metal sheet, or the slit diaphragm may be cleaned simply by backwashing, brushing, or burning, since there is generally no substantial contamination by material at any depth within the layers of the mesh.

In one particularly preferred embodiment, the apparatus of the invention is an extruder with at least two corotating or counterrotating screws, the extruder being substantially composed of the following in the conveying direction (the downstream direction)
at least one metering section into which a thermoplastic comprising water is introduced into the extruder by a metering means,
if desired, at least one squeeze section which serves for dewatering the thermoplastic and comprises at least one retarding element, and in each case comprises at least one associated dewatering orifice which, if desired, may have been equipped with an MCS, with a finely perforated sheet, or with a slit diaphragm,
if desired, at least one feed section in which further thermoplastic is introduced as melt into the extruder,
at least one plastication section provided with mixing, kneading, and/or other plastication elements,
at least one devolatilization section which has at least one devolatilization orifice and in which the remaining water is removed as vapor, where at least one of the devolatilization orifices has been equipped with an MCS, with a finely perforated metal sheet, or with a slit diaphragm, and
a discharge zone.

Among these, preference is given to extruders which have at least one feed section. Among the extruders mentioned, preference is moreover given to those which encompass at least one squeeze section. Particularly preferred extruders include those which encompass at least one feed section and also at least one squeeze section.

The apparatus of the invention may be used to extrude a thermoplastic, which can be devolatilized and at the same time dewatered. It is also possible for the apparatus to be fed with a mixture of water and thermoplastics, e.g. a slurry of thermoplastic in water, and for this to be extruded. In that case the water content of the thermoplastic is up to 90% by weight, for example. It is also possible to extrude a mixture of various thermoplastics. According to the invention, the apparatus may also be used to prepare a thermoplastic from a water-moist component comprising up to 60% by weight of residual water, by feeding this component to the apparatus, dewatering it at least to some extent and mixing it with other components, and then discharging the thermoplastic. This method is preferably used to prepare toughened thermoplastics or polymer blends comprising toughened thermoplastics.

In one preferred embodiment, the apparatus of the invention may be used to prepare toughened thermoplastics or polymer blends comprising toughened thermoplastics or by mixing at least one water-moist elastomer component A comprising up to 60% by weight of residual water with at least one thermoplastic polymer B, and also with other polymers C and additives D, in an extruder, with mechanical dewatering of the elastomer component A.

One particularly preferred apparatus and one particularly preferred processing system are illustrated in more detail below. The constituents of the apparatus are termed sections or zones but are not necessarily identical with the individual components such as barrel sections, screw segments, used to assemble the apparatus. A section or a zone is generally composed of more than one component.

In a preferred embodiment, the apparatus is a twin-screw extruder. However, it is also possible to use an extruder having three or more screws or an extruder having a main screw of large diameter and, arranged around this, small screws (planetary arrangement).

The screws of the extruder, furthermore, preferably rotate in the same direction. However, rotation in opposite directions is also possible. Particular preference is given to a twin-screw extruder having screws rotating in the same direction.

The water-moist elastomer component A containing up to 60% by weight of residual water is, as a rule, a moist solid. It is, for example, a graft rubber which was obtained by emulsion polymerization, precipitated and partially dewatered to a residual water content of up to 60% by weight, where the partial dewatering may be effected, for example, by filtration, settling out, pressing out, decanting, centrifuging or thermal drying; it is fed to the metering section of the extruder. The metering section usually consists of an automatic metering means and the actual metering orifice. The metering means is in the form of, for example, a conveying screw which conveys or forces the conveyed material into the metering orifice. It is also possible for component A to be metered by suitable gravimetric or volumetric metering means and to be metered under gravity into the feed orifice of the extruder. The component A is drawn in and vented by means of a suitable screw geometry in the metering section. The venting may take place via one or more orifices, either unsealed or sealed by an MCS, by a finely perforated metal sheet, or by a slit diaphragm, and arranged upstream or downstream of the metering orifice.

If there are a number of elastomer components A, these may be metered together or separately from one another into the same metering orifice or into different metering orifices of the metering section 2.

In a possible embodiment, a section 1 is located upstream in the direction opposite the conveying direction of the extruder. It may serve for dewatering, preferably for drainage, and/or for venting. Typically, it has one or more vent orifices through which included air can escape. It may also have one or more dewatering orifices, which preferably serve for drainage. According to the invention, one, more than one, or all of these dewatering orifices may have been provided with an MCS, with a finely perforated metal sheet, or with a slit diaphragm. In one of the preferred embodiments, use may be made of an MCS.

In a further embodiment, the component C and/or the component D or proportions of the total added amount of components C and/or D are metered into one or more further orifices arranged in the vent section. If both components C and D are fed in, this may be done by feeding said components together through one orifice or through different orifices (one each for C and D).

In another, preferred embodiment, the component C and/or the component D or proportions of the total added amount of components C and/or D are metered into the metering orifice of the metering section or into one or more further orifices arranged in the metering section. This may also be effected in a further metering section 2′ which is downstream of the first metering section 2 and for which essentially the statements made in connection with section 2 are applicable. According to the invention, the metering section 2 and/or the further metering sections 2′ may have been provided with one or more dewatering orifices, which likewise preferably serve for drainage. According to the invention, these may have been provided with an MCS, with a finely perforated metal sheet, or with a slit diaphragm, an MCS being preferred.

Components C and D can be fed into the metering sections of the extruder, separately from A or together with A in one of the following combinations: A+C+D, A/C+D, A+C/D, A+D/C and A/C/D (where / means separately from, each by means of a separate orifice, and + means together with, through a common orifice).

In both stated embodiments, the metering means for the components C and/or D may be, for example, a conveying screw as in the case of the metering of the elastomer component A, a pump or an extruder, depending on the state of aggregation of C and D.

In the region of the metering sections and—if present—in the vent section, the extruder screws are formed, as a rule, as conventional conveying screws. For the purposes of this application, conventional conveying screws are, for example, elements having an earth mixer profile (completely self-purging), elements having a thrust edge, elements having a trapezoidal profile and elements having a rectangular profile, screw elements having conveying threads of large pitch (pitch larger than the diameter of the screw) in the conveying direction (termed RGS elements) or combinations of these elements, it also being possible for the screws to be equipped with a smaller or larger number of flights compared with the squeeze section. Double-flight and single-flight or double-flight or triple-flight screw elements may also be used together here. The screw elements of the conveying screw may be identical or different in the stated sections.

The water-moist elastomer component is conveyed downstream into the first squeeze section.

In the first squeeze section 3, a part of the residual water contained in the elastomer component is mechanically removed. The material is conveyed against a retarding element which acts as an obstacle and is present, as a rule, at the end of the squeeze section. This builds up a pressure, which forces water out of the elastomer component. The pressure can be built up by different arrangements of screw elements, kneading elements or other retarding elements, depending on the rheological behavior of the rubber. In principle, all commercial elements in the apparatus serving for building up the pressure are suitable.

Examples of possible retarding elements are
pushed-over, conveying screw elements
screw elements having a pitch opposite to the conveying direction, including screw elements having conveying threads of large pitch (pitch larger than the diameter of the screw) opposite to the conveying direction (termed LGS elements)
kneading blocks having nonconveying kneading disks of different width
kneading blocks having a back-conveying pitch
kneading blocks having a conveying pitch
barrel disks, eccentric disks and blocks configured therefrom
toothed mixing elements of various design
neutral retarding disks (baffles)
mechanically adjustable restrictors (sliding barrel, radial restrictors, central restrictors).

Two or more of the retarding elements may be combined with one another. The retarding effect can also be adapted to the respective elastomer by means of the length and the intensity of the individual retarding elements.

In the squeeze section, the screw elements situated before the restricted flow zone (before the first retarding element) are generally constructed as conventional conveying screws. In an embodiment, the conveying screws used here have a helix angle which becomes shallower toward the restricted flow zone. This construction brings about a relatively slow rise in pressure, the term transition zone being frequently used, which can be advantageous for dewatering certain elastomer components.

In another preferred embodiment, mixing elements and/or kneading elements, examples of which are given below for the plastication section 5, are used in the squeeze section between the dewatering orifice and the first retarding element. This embodiment can be advantageous in particular for certain consistencies and morphologies of the elastomer component.

In the first squeeze section, all structural features and all operating parameters of the extruder are preferably tailored to one another in such a way that, at the chosen screw speed, the elastomer material is conveyed and compressed but is plasticated or partly melted only to a minor extent, if at all, and is not completely melted.

The squeeze section 3 of the extruder preferably contains, for a pressure build-up, screw elements having a pitch opposite to the conveying direction and/or corresponding kneading blocks.

The water forced out of the elastomer material in the first squeeze section leaves the extruder in the liquid phase and not as steam. In a less preferred embodiment, up to 20% by weight of the water removed in this section emerge as steam.

The squeeze section is provided with one or more dewatering orifices which are generally under atmospheric pressure or superatmospheric pressure. The number, arrangement, and design of these generally depends on the water content of the extrusion material and on the desired content of residual water in the final product. The location of the dewatering orifices is preferably approximately in the middle of the squeeze section. An example of a location of the dewatering orifices is on the upper side of the extruder, but their arrangement may also be lateral or downward-facing. For example, one or more dewatering orifices may have been arranged perpendicularly to the extruder axis arranged on an imaginary circle around the extruder axis. It is also possible for there to be dewatering orifices toward the top, toward the base, or on both sides of the extruder axis. Another possibility is a helical arrangement around the extruder axis and perpendicular thereto. According to the invention, at least some of the dewatering orifices may have been covered by an MCS, by a finely perforated metal sheet, or by a slit diaphragm. The dewatering orifices which do not have this provision have, furthermore, preferably been provided with an apparatus which hinders the discharge of the conveyed elastomer A. Devices termed retaining screws are particularly preferably used for this purpose.

The design of the dewatering orifices is known per se. It is preferable to use dewatering orifices whose dimensioning has been selected so that the orifices cannot be blocked by the contents of the extruder. It is particularly preferable for the dewatering orifices used to comprise cutouts or holes in the extruder barrel. The risk of blocking which has been repeatedly mentioned, and the high content of fine particles of solid discharged, mean that it is preferable to avoid using Seiher housings.

According to the invention, the dewatering orifice belonging to the retarding elements may be located before the retarding element or, in the case of a plurality of retarding elements, before the first retarding element upstream by a distance corresponding to at least one screw diameter D_{Screw}, preferably from 1 to 4 D_{Screw}, very particularly preferably from 1 to 3.5 D_{Screw}. Distance is to be understood as the distance between the middle of the dewatering orifice and the beginning of the first retarding element.

As a result of this distance between retarding elements and dewatering orifice, the dewatering orifice is not present in that region of the extruder in which the pressure of the polymer conveyed against the retarding elements is very high (pressure maximum).

The temperature of the emerging water is in general from 20 to 95° C., preferably from 25 to 70° C., measured at the outlet orifice.

To improve the dewatering performance of the first squeeze section, it can be advantageous to use retarding elements and/or kneading elements in the metering section or between the metering section and the first dewatering orifice. The type and number of these retarding and/or kneading elements are selected so that the elastomer component is subjected to a degree of mechanical load, thus changing its nature so that it becomes easier to dewater, but not, or only to a subordinate extent, plasticizing it or causing it to begin to melt, and certainly not melting it completely.

In the first squeeze section, from 10 to 90, preferably from 20 to 80, % by weight of the initially contained residual water are usually removed, depending on the elastomer component and on the residual water content initially present.

In a preferred embodiment, the extruder is not heated in the metering sections and in the squeeze sections. In one embodiment, the extruder is cooled in these stated sections.

The partially dewatered elastomer component A is transported away via the retarding zones and enters the next extruder section.

In an embodiment preferred for the preparation of some impact-resistant thermoplastics, the first squeeze section 3 just described is followed by a second squeeze section 3′, which in turn consists of a conveying section and a retarding zone effective as an obstacle. The statements made in connection with the first squeeze section 3 are essentially applicable to this section, including in particular in relation to the nature of the MCSs, finely perforated metal sheet, or slit diaphragm used.

In the optional second squeeze section, the elastomer component is further dewatered, once again up to 80, preferably up to 65, % by weight of the water present initially (before the extrusion) eing removed. As a result of the mechanical energy introduced by the rotating extruder screw, the temperature of the elastomer component in the second squeeze section generally increases to values up to 250° C.

The process is preferably designed so that the contents of the extruder are exposed to temperatures which are as low as possible. The extruder is therefore preferably designed and operated so that the temperature of the elastomer component does not exceed 200° C., particularly preferably 180° C. These temperatures are based on the restricted flow zones.

From 20 to 99% by weight of the water removed in the second section emerges as liquid, and the remaining amount to 100% by weight as steam. However, the dewatering orifices are preferably designed so that the amount of water emerging in liquid form is 70% by weight or more, in spite of the high material temperature. For this purpose, the geometries of extruder screws and, where appropriate, of the retaining screws are designed in such a way that the water remains predominantly in liquid form, for example as a result of a pressure build-up in the outlet zone or as a result of other measures. According to the invention, the dewatering orifices in this squeeze section may also have been provided with an MCS, with a finely perforated metal sheet, or with a slit diaphragm. Any retention of pressure needed generally takes place outside of the MCS, of the finely perforated metal sheet, or of the slit diaphragm, in the exhaust lines.

The temperature of the water at the discharge orifice is generally from 40 to 130° C., preferably from 50 to 99° C., or else is higher under superatmospheric pressure.

The partially dewatered elastomer component can be melted to a relatively large extent or completely melted at the end of the second squeeze section 3′ and can be present in the form of relatively large fused agglomerates.

The extruder may contain further squeeze sections behind the second squeeze section 3′, particularly when the initial residual water content of the elastomer component A is high.

The water which is squeezed out generally leaves the extruder through all of the dewatering orifices which are present. Depending on the properties of the elastomer component and on the amount which is metered in (degree of filling of the extruder) and its residual water content, it is also possible, however, that the water which is squeezed out is not discharged at all of the available dewatering orifices, and the other dewatering orifices can be described as dry, ie. no or virtually no water passes out therethrough. This has proven not to be at all disadvantageous.

In a preferred embodiment, the water removed in the squeeze sections can be collected and, for example, used in the preparation of components A, B, C and/or D. Thus, the water which is squeezed out may, for example, be used again in the preparation of the elastomer component A or for precipitating the rubber from its latex. This recycling of the water improves the cost-effectiveness and the environmental compatibility of the process, since there is less waste water.

After passing the last squeeze section, the elastomer component has been freed from a considerable part of the residual water (component A′) and enters a feed section 4 in which one or more feed orifices for the thermoplastic polymer B are present. It is advantageous that the polymer B is introduced in the form of its melt. If the section contains a plurality of feed orifices, these may be arranged, for example, one behind the other along an imaginary axis in the longitudinal direction of the extruder, in a circle along the extruder circumference or along an imaginary helix around the extruder.

The melt of the polymer B can be fed in by means of an extruder or by conveying means, such as melt pumps or metering screws.

In the feed section 4 described, the component C and/or the component D or proportions of the total added amount of the components C and/or D may be introduced into the extruder, in addition to the melt of a thermoplastic polymer B. These components may be present as a melt or liquid and in this case are generally metered in by metering means as also used for feeding the melt of the polymer B or, if the component is liquid, by means of a liquid pump. In the case of solid components C and/or D, the metering is usually effected as described in the case of component A.

The components C and D can be fed to the extruder separately from B or together with B, in one of the following combinations: B+C+D, B/C+D, B+C/D, B+D/C and B/C/D (where / means separately from, each by means of a separate orifice, and + means together with, through a common orifice).

The components C and/or D or proportions of the total added amount of the components C and/or D, in unmelted or not completely melted form, may also be fed to section 4 or the above-described sections 1 and 2 of the extruder by means of a positive metering element. Such a metering element is, for example, an extruder, in particular a twin-screw extruder having intermeshing screws running in opposite directions.

The use of an extruder (ie. side extruder) or of a metering pump as a metering means for the components C and/or D is preferred.

In the region of feed section 4 in which the melt of the thermoplastic polymer B and, if required, the components C and/or D are fed in, the screw may advantageously be in the form of a conveying screw which is capable of homogenizing the mixture of elastomer component A and the melt of thermoplastic B and, if required, components C and/or D only to a small extent. The statements made with regard to the metering section are applicable to the design of the conveying screw. However, it is also possible to use mixing elements and/or kneading elements in this region.

In a preferred embodiment, in addition to section 4 which is present between the (last) squeeze section and the (first) plastication section 5 (see below), the extruder has, at another point, further sections 4′, 4″, etc. in which a melt of the thermoplastic polymer B is likewise fed in. In particular, these further feed sections 4′, 4″, etc. are located downstream in the region behind the feed section 4 and before the end of the extruder.

The feeding of the melt of B via a number of feed sections, 4, 4′, 4″, etc. can be advantageous in particular if specific product formulations are desired. In a preferred embodiment, there are further feed sections 4′, 4″, etc. for the melt of the thermoplastic polymer B downstream between the plastication and devolatilization sections, between two devolatilization sections, between the last devolatilization section and the discharge zone, or in the discharge zone.

If the melt of B (or C or B and C) is fed to the extruder via a number of feed sections 4, 4′, 4″, etc., the distribution of the total amount of B across the different sections 4, 4′, 4″, etc. can vary within wide limits. In the case of two feed sections 4 and 4′, the weight ratio [melt of B in section 4/melt of B in section 4′] may be from 9.5:0.5 to 0.5:9.5, preferably from 9:1 to 1:9, and particularly preferably from 8.5:1.5 to 1.5:8.5. The properties of the product of the process can be influenced to a certain extent by distributing the total amount of B across the individual sections 4, 4′, 4″, etc.

The feed section for the thermoplastic melt B and, if required, components C and/or D is followed by a plastication section 5 which is provided with mixing, kneading and/or other plastication elements.

The mixing and/or kneading elements homogenize the polymer blend with simultaneous melting of the dewatered elastomer component A′ and, if required, of the components C and/or D.

Suitable mixing and kneading elements are the components familiar to a person skilled in the art, for example
screw elements having a small pitch in the conveying direction,
kneading blocks having narrow or broad, conveying or nonconveying kneading disks,
screw elements having a pitch opposed to the conveying direction,
barrel disks, eccentric disks and blocks comprising these disks,
toothed mixing elements or
melt mixing elements
   or a combination of such elements. It is also possible to use the screw elements given as examples for the retarding elements, since each retarding element generally also has a mixing effect. Preference is given to the use of different combinations of kneading blocks as mixing and kneading elements for plastication. Baffles may also be used with advantage. All of the abovementioned elements may be used in normal designs corresponding to the diameter of the extruder barrel or else as a specific design with reduced diameter.

Furthermore, all of the abovementioned elements may also be modified in another manner, eg. to achieve gentle processing conditions for the contents of the extruder, or more intensive mixing. Conveying threads and/or kneading blocks may be provided with intermeshing elements having apertures and/or reduced diameters.

The choice of the type, number and dimensions of the screw elements in the plastication section depends on the components of the polymer mixture, in particular on the viscosity and softening temperature and the miscibility of the components.

The extruder may contain one or more further plastication sections 5′ after the plastication section described, for example if the homogenization and the melting of the blend was incomplete in the first plastication section.

The statements made in connection with the first plastication section are correspondingly applicable to the further plastication section or sections.

It is possible to feed the component C and/or the component D or proportions of the total added amount of the components C and/or D to at least one of the plastication sections, these components being fed separately from one another through different orifices or together through a common orifice.

In a preferred embodiment, the melt of the thermoplastic polymer B and, if required, the components C and/or D are fed to the extruder at the beginning of the plastication section. In this embodiment, the section 4 for feeding in the thermoplastic accordingly coincides with the beginning of the plastication section 5.

In a further particular embodiment of the extruder, one or more further plastication sections are present before section 4 in which the melt of the thermoplastic polymer is fed in, ie. behind the last squeeze section. In this plastication section 5″, the very substantially dewatered elastomer component A′, for example the rubber powder, is first homogenized and plasticated alone.

The melt of the thermoplastic polymer B and, if required, the components C and/or D are accordingly introduced into a viscous melt of the elastomer component A′ in this embodiment. In this case, the plastication section 5 downstream of the mixing of melt B and C and/or D (section 4) serves merely for homogenizing the mixture of the components already present in the plastic state.

The choice of the variants described for feeding in melt B and optionally the components C and/or D, ie.
into a conveying section before the plastication section,
at the beginning of the plastication section,
into a conveying section between two plastication sections,
   depends on the ratios and on the physical and chemical properties of the components A, B, C and D to be mixed. The viscosities of the melts of elastomer component A′ and thermoplastic polymer B and (if metered into this part of the extruder) of the components C and/or D, the softening temperatures of the components, their thermal load capacity or tendency to decompose at relatively high temperatures, the compatibility in terms of miscibility or wettability of the components, the residual water content of the polymer blend comprising elastomer component A′ and thermoplastic polymer B and, if required, the components C and D and, in the case of particulate components, their particle size and particle size distribution may be mentioned merely by way of example.

The apparatus of the invention has one or more devolatilization sections 6 and 6′, each provided with one or more devolatilization orifices. The remaining residual water not removed mechanically in the squeeze sections is partially or completely removed in the devolatilization sections. There may be devolatilization sections prior to the first feed section 4. They may also have been arranged behind the same (downstream). It is also possible for there to be a devolatilization section arranged prior to the first feed section 4 and a devolatilization section arranged behind the first feed section 4. For example, in one preferred embodiment it is also possible to arrange one or more devolatilization sections between two feed sections 4 and 4′. In one likewise preferred embodiment, the arrangement of the devolatilization sections and feed sections may be such that devolatilization can take place prior to and after each introduction of a melt. In another preferred embodiment, it is possible to arrange one or more additional devolatilization sections after the final plastication section. In another preferred embodiment, the devolatilization sections arranged after the final plastication section may be the only devolatilization sections of the apparatus. Since the temperatures of the polymer melt are usually above 100° C., the water is mostly discharged entirely as vapor. The energy needed to evaporate the water is introduced by way of the squeezing action and the plastication, and/or by way of the melt feed.

The arrangement of the devolatilization orifices, and their geometry, may be as described at the outset. Particular preference is given to an apical, basal, or lateral arrangement with a rectangular, circular, or twin-figure-of-eight cross section.

The devolatilization orifices may be operated under atmospheric, reduced or superatmospheric pressure, and the pressure to which each of the devolatilization orifices is subjected may be identical or different. The moisture content of the extrusion material at this point may be controlled within certain limits via appropriate pressure build-up or vacuum. In the case of reduced pressure, the absolute pressure is usually from 2 to 900 mbar, preferably from 10 to 800 mbar, particularly preferably from 30 to 500 mbar. In the case of devolatilization under superatmospheric pressure, the absolute pressure set is generally up to 20 bar. However, it is preferable for the devolatilization sections to be operated under atmospheric pressure or reduced pressure.

The number of devolatilization sections and, as described at the outset, the number, arrangement and dimensions of the devolatilization orifices depend advantageously on the water content of the polymer entering the devolatilization sections and on the desired water content of the end product. In a preferred embodiment, an extruder having two or three devolatilization sections is used.

According to the invention, at least one of the devolatilization orifices of the extruder has been equipped with an MCS, with a finely perforated metal sheet, or with a slit diaphragm of the type specified at the outset. Among these, particular preference is given to MCSs. The other devolatilization orifices have no covering or may preferably have been provided with other apparatus, e.g. retaining screws. It is also possible for one of the devolatilization orifices to have been equipped with an MCS and for the others to have been equipped with a finely perforated metal sheet.

Following the removal of a part of the residual water contained in the elastomer component A in the squeeze sections 3 and 3′, from about 10 to 80, preferably from 20 to 75, % by weight of the residual water contained in the elastomer component A before extrusion are removed in all devolatilization sections 6 and 6′ together.

In the region of the devolatilization sections, the extruder screws are generally in the form of conventional conveying screws, as described for the metering sections. It can, however, be useful to incorporate kneading or mixing elements into the screws in the region between the devolatilization orifices, in order to replace energy consumed in evaporating the water.

In a preferred embodiment, the extruder has, between the last devolatilization section and the discharge zone, a further section 7 in which the components C and/or D (or proportions of the total added amount of components C and/or D) are fed to the extruder, either together or separately from one another, by at least one metering means.

This further section 7 is provided with mixing, kneading and/or other plastication elements, as mentioned by way of example for the plastication sections. They homogenize the polymer blend.

The metering means required for feeding in C and/or D have also already been described.

Kneading blocks having nonconveying kneading disks and/or kneading blocks having a conveying pitch, kneading blocks having different land widths, toothed mixing elements and melt mixing elements are preferably used as mixing and/or kneading elements, and extruders having one or two screws (ie. side extruders) and/or pumps, in paraticular melt pumps, are preferably used as metering means.

In a preferred embodiment, the total amount of the components C and/or D which are to be introduced into the extruder is fed to the extruder either in the further section 7 or in the metering section 2, or in the further section 7 and in the metering section 2.

The components C and/or D may be added together through at least one feed orifice or separately through a plurality of feed orifices.

The last section of the extruder is the discharge zone 8. It consists of a conveying screw and a closed barrel part which is terminated by a defined discharge orifice.

A preferably used discharge orifice is a die head which is formed, for example, as a die plate or die strip, where the dies may have a circular (perforated die plate), slot-like or other shape. The product discharged as an extrudate in the case of a perforated die plate is cooled, for example in water, and granulated in the usual manner. Particularly where a slot die is used, cube granulation is possible.

In a particular embodiment, instead of the perforated die strip described above, with the otherwise usual combination of extrudate take-off, water bath and granulator, a particular die head with subsequent underwater granulation is used. Here, the polymer melt passes through a die plate having preferably round holes arranged in a circle, is cut under water by rotating blades and is cooled under water, the polymer solidifying to more or less round, bead-like particles. With regard to the arrangement of the holes, however, arrangements other than circular ones and hole shapes other than round ones are also commonly used.

In a further embodiment, a hot face cutting method is used instead of the discharge via a die strip, cooling in a water bath and granulation, the polymer melt emerging from the die head not being cooled by liquid but, after emergence from the die head, being comminuted (granulated) while still in the hot state, after brief cooling in air. The resulting granules are then further cooled (for example by spraying with water) or cooled during further processing if this is necessary. Further processing in the hot state or direct extrusion of sheets, films, pipes and profiles is also possible.

In a further embodiment, underwater extrudate granulation is used, in which the melt is discharged as extrudate from a die plate and is immediately wetted by a stream of water and is then introduced, via a sloping plane, into a water bath, and is granulated after cooling.

In a further particular embodiment, the discharge zone 8 is provided with an apparatus for filtering the melt emerging from the extruder, said apparatus, viewed in the conveying direction, being present before the die head. Such apparatuses for continuous melt filtration are known to a person skilled in the art and are commercially available. If necessary, a conveyor element, for example a melt pump or a screw conveyor, may be installed between discharge zone and melt filtration in order to build up in the melt the pressure required for passing through the filter unit.

The melt emerging from the filtration apparatus is granulated and is further processed by another method, as described above.

The water content of the emerging polymer (the extrudate moisture content) is as a rule from 0.05 to 1.5% by weight, based on this polymer. The temperature of the polymer melt emerging from the discharge orifice is as a rule from 180 to 350° C., depending on the type of polymers used.

As is generally known, the various zones of an extruder can be individually heated or cooled in order to establish an optimum temperature profile along the screw axis. Furthermore, it is familiar to a person skilled in the art that the individual sections of the extruder may usually be of different lengths. To achieve particular product properties, it may specifically be useful to cool certain parts of the extruder or to control their temperature so that it diverges from that of the remainder of the extruder.

The temperatures and lengths of the individual sections to be chosen in the specific case differ depending on the chemical and physical properties of the components and their ratios, said properties having been mentioned above by way of example.

The same also applies to the screw speed, which may vary within a wide range. A speed of the extruder screws of from 50 to 1800 rpm may be mentioned merely by way of example. A speed range of from 100 to 700 rpm is preferred.

It is advantageous to design and to operate the extruder in such a way that mean shear rates of from 15 to 450 s⁻¹ are established in the region of the squeeze sections at a screw speed of from 50 to 1200 rpm. Shear rates of from 35 to 260 s⁻¹ are advantageously established for the preferred screw speed of from 100 to 700 rpm. However, depending on the type, amount and properties of the components used, it may be advantageous to operate at mean shear rates outside this range.

The extruder screws may be any commercially available screw, for example a screw having an external diameter of from 10 to 1000 mm. The screw diameter which is suitable depends on, for example, the type and amount of the components metered into the extruder. The external diameter of the screw may be constant along the extruder or vary within particualr limits.

Depending on the type and amounts of the components, screws having a smaller flight depth or screws having a larger flight depth (ie. deep-flighted screws) may be used in the extruder. Preference is given to the use of screws having a flight depth ratio D_{Screw, external}/D_{Screw, internal} of from 1.2 to 1.8, preferably from 1.4 to 1.6, and particularly preferably from 1.45 to 1.58. A commercially available embodiment of the extruder which is suitable for the novel process has, for example, a flight depth ratio of 1.55, ie. a large flight depth.

In another embodiment, screws having a medium flight depth, particularly those having a flight depth ratio of from 1.4 to 1.48, are used. This embodiment of the extruder may be advantageous for certain components and certain amounts of the components. Screws with flight depth ratios of more than 2 are also suitable.

The number of starts of the screw may vary, in particular with n being 1 or 2 or 3. Double-flight screws are preferably used. However, screws having other numbers of starts or those screws which have sections with different numbers of starts may also be used.

Use may in particular be made of extruder screws in which the flight depth ratio varies along the screw, there being a relationship between the number of starts and the flight depth ratio (multi-stage screw). Use may preferably be made of a screw in which the change from 3 to 2 starts is accompanied by a change in the flight depth from a low to a high flight depth ratio.

All of the embodiments described of the process have the common feature that the introduction of the components C and/or D into the extruder does not take place in the regions where the extruder contents are subject to high pressure (generated by elements which increase pressure). Instead, C and/or D are metered in at an adequate distance prior to or after these regions, or at “zero pressure”, i.e. merely against the usual pressure generated by a screw element with neutral conveying action.

Any polymer which has elastomeric properties and can be fed into an extruder may be used as the elastomer component A. A mixture of different elastomer components A may also be used.

In particular, particulate rubbers are used as component A, as mentioned at the outset. Those rubbers which have a grafted-on shell comprising other, generally nonelastomeric polymers are particularly preferred. In a preferred embodiment of the invention, the graft rubber types fed to the extruder as partially dewatered material contain up to 50, particularly preferably from 25 to 40, % by weight of residual water.

One embodiment of the invention consists in a process in which elastomer components A used are graft rubbers which have a two-stage or multistage structure and in which the elastomeric base or graft stages are obtained by polymerization of one or more of the monomers butadiene, isoprene, chloroprene, styrene, alkylstyrene, C₁-C₁₀-alkyl esters of acrylic acid or of methacrylic acid and small amounts of other monomers, including crosslinking monomers, and in which the hard graft stages are obtained by polymerizing one or more of the monomers styrene, alkylstyrene, acrylonitrile and methyl methacrylate.

Graft particles A of polymers based on butadiene/styrene/acrylonitrile, n-butyl acrylate/styrene/acrylonitrile, butadiene/n-butyl acrylate/styrene/acrylonitrile, n-butyl acrylate/methyl methacrylate, n-butyl acrylate/styrene/methyl methacrylate, butadiene/styrene/acrylonitrile/methyl methacrylate and butadiene/n-butyl acrylate/methyl methacrylate/styrene/acrylonitrile are preferred. Polar monomers carrying up to 10% by weight of functional groups or crosslinking monomers may be present as polymerized units in the core or shell.

In this embodiment, styrene/acrylonitrile (SAN) copolymers, polystyrene, polymethyl methacrylate, polyvinyl chloride or mixtures of these polymers are used as thermoplastic polymers B.

SAN polymers, polymethyl methacrylate (PMMA) or mixtures of these polymers are preferred.

Polycarbonates, polyalkylene terephthalates, such as polybutylene terephthalate and polyethylene terephthalate, polyoxymethylene, polymethyl methacrylate, polyphenylene sulfide, polysulfones, polyether sulfones and polyamides and mixtures of these thermoplastics may also be used as thermoplastic polymers B. Thermoplastic elastomers, such as thermoplastic polyurethane (TPU), may furthermore be used as polymer B.

Copolymers based on styrene/maleic anhydride, styrene/imidated maleic anhydride, styrene/maleic anhydride/imidated maleic anhydride, styrene/methyl methacrylate/imidated maleic anhydride, styrene/methyl methacrylate, styrene/methyl methacrylate/maleic anhydride, methyl methacrylate/imidated maleic anhydride, styrene/imidated methyl methacrylate, imidated PMMA or mixtures of these polymers may likewise be used as component B.

In all stated thermoplastic polymers B, some or all of the styrene may be replaced by α-methylstyrene or by styrenes alkylated on the nucleus or by acrylonitrile.

Among the last-mentioned polymers B, those based on α-methylstyrene/acrylonitrile, styrene/maleic anhydride, styrene/methyl methacrylate and copolymers containing imidated maleic anhydride are preferred.

Known examples of the elastomer component A are polymers of conjugated dienes, such as butadiene, having an outer graft shell based on a vinylaromatic compound, for example SAN copolymers. Graft rubbers based on crosslinked polymers of C₁-C₁₀-alkyl esters of acrylic acid, such as n-butyl acrylate or ethylhexyl acrylate, grafted with polymers based on vinylaromatic compounds, such as SAN copolymers, are also known. Graft rubbers which essentially contain a copolymer of conjugated dienes and C₁-C₁₀-alkyl acrylates, for example a butadiene/n-butyl acrylate copolymer, and an outer graft stage comprising SAN copolymer, polystyrene or PMMA are also conventionally used.

The preparation of such graft rubbers by the usual methods, in particular by emulsion or suspension polymerization, is known.

Graft rubbers based on SAN-grafted polybutadiene are described, for example, in DT 24 27 960 and EP-A 258 741, and those based on SAN-grafted poly-n-butyl acrylate are described in German Application DAS 1,260,135 and German Laid-Open Application DOS 3,149,358. Further details of SAN-grafted poly(butadiene/n-butyl acrylate) mixed rubbers are given in EP-A 62 901.

In the case of the graft rubbers mentioned in the last paragraph, copolymers of styrene and acrylonitrile are used as thermoplastic polymers B. They are known and some of them are also commercially available and have, as a rule, a viscosity number VN (determined according to DIN 53 726 at 25° C., 0.5% strength by weight in dimethylformamide) of from 40 to 160 ml/g, corresponding to an average molecular weight M_{w} of from about 40000 to 2000000.

The thermoplastic polymers B are preferably prepared by continuous mass or solution polymerization, the melt obtained being fed continuously and directly to the extruder, for example by means of a melt pump, if necessary after removal of the solvents. However, preparation by emulsion, suspension or precipitation polymerization is also possible, the polymer being separated from the liquid phase in an additional operation. Details of the preparation processes are described, for example in Kunststoffhandbuch, Editors R. Vieweg and G. Daumiller, Vol. V “Polystyrol”, Carl-Hanser-Verlag, Munich, 1969, page 118 to page 124.

If the elastomer component A is an SAN-grafted polybutadiene, a molding material known as ABS (acrylonitrile/butadiene/styrene) is formed by incorporating the SAN. If an SAN-grafted alkyl acrylate is used as component A, ASA molding materials (acrylonitrile/styrene/acrylate) are formed.

In another embodiment, graft rubbers having a residual water content of up to 60% by weight and based on polydienes and/or polyalkyl acrylates as well as SAN and/or PMMA are used, said rubbers being composed of more than two graft stages.

Examples of such multistage graft particles are particles which contain a polydiene and/or polyalkyl acrylate as the core, a polystyrene or SAN polymer as the first shell and another SAN polymer having a different styrene:acrylonitrile weight ratio as the second shell, or particles comprising a polystyrene, polymethyl methacrylate or SAN polymer core, a first shell of polydiene and/or polyalkyl acrylate and a second shell of polystyrene, polymethyl methacrylate or SAN polymer. Further examples are graft rubbers comprising a polydiene core, one or more polyalkyl acrylate shells and one or more polymer shells of polystyrene, polymethyl methacrylate or SAN polymer or similarly composed graft rubbers having an acrylate core and polydiene shells.

Copolymers having a multistage core-shell structure of crosslinked alkyl acrylate, styrene and methyl methacrylate and an outer shell of PMMA are also commonly used.

Such multistage graft rubbers are described, for example, in German Laid-Open Application DOS 3,149,046. Graft rubbers based on n-butyl acrylate/styrene/methyl methacrylate and having a shell of PMMA are described, for example, in EP-A 512 333, any other prior art composition of such graft rubbers also being possible.

Such rubbers are used as impact modifiers for polyvinyl chloride and preferably for impact-resistant PMMA.

Once again, the stated SAN copolymers and/or PMMA are used as thermoplastic polymers B.

If the elastomer component A is a multishell core/shell polymer based on n-butyl acrylate/methyl methacrylate and the polymer B is PMMA, impact-resistant PMMA is accordingly obtained.

The diameter of the particulate graft rubbers is from 0.05 to 20 μm. If these are the generally known graft rubbers of small diameter, the diameter is preferably from 0.08 to 1.5 μm, particularly preferably from 0.1 to 0.8 μm.

In the large-particled graft rubbers prepared advantageously by means of suspension polymerization, the diameter is preferably from 1.8 to 18 μm, in particular from 2 to 15 μm. Such graft rubbers of large diameter are described, for example, in German Laid-Open Application DOS 4,443,886.

In this embodiment too, preferred components B are the stated SAN copolymers, polystyrene and/or PMMA.

The components C are further polymers, in particular thermoplastic polymers. Suitable components C are all polymers which were mentioned for the thermoplastic polymer B. The polymers B and C generally differ in the monomers used.

If the monomers of which the polymers B and C are composed are identical, the components B and C generally differ with respect to the amounts of the monomers—for example the polymers B and C may be styrene/acrylonitrile copolymers which differ in the styrene:acrylonitrile ratio. If the amounts of the monomers are also identical, the polymers B and C have different average molecular weights M_{w}(B) and M_{w}(C), measurable, for example, as different viscosity numbers VN(B) and VN(C).

In addition to the monomers mentioned inter alia for the component B, ie. styrene, acrylonitrile, methyl methacrylate and vinyl chloride, the following other compounds may also be used as essential monomers for the preparation of C:
α-methylstyrene and styrenes or α-methylstyrenes each of which is substituted on the nucleus by C₁-C₈-alkyl
methacrylonitrile
C₁-C₂₀-alkyl esters of acrylic acid and of methacrylic acid
maleic acid, maleic anhydride and maleimides
vinyl ethers and vinylformamide.

Polymers based on α-methylstyrene/acrylonitrile and methyl methacrylate/alkyl acrylate, and copolymers of alkyl esters of acrylic acid or of methacrylic acid and styrene or acrylonitrile or styrene and acrylonitrile are examples of the component C.

Further preferred polymers C are
styrene/acrylonitrile copolymers having different amounts of the monomers compared with the component B, or different average molecular weights M_{w},
copolymers of α-methylstyrene and acrylonitrile,
polymethyl methacrylates,
polycarbonates,
polybutylene terephthalate and polyethylene terephthalate,
polyamides,
copolymers of at least two of the monomers styrene, methyl methacrylate, maleic anhydride, acrylonitrile and maleimides, for example copolymers of styrene, maleic anhydride and phenylmaleimide,
ABS prepared by means of mass polymerization or solution polymerization,
thermoplastic polyurethanes(TPU).

The preparation of these polymers is known to a person skilled in the art and is therefore discussed only briefly below.

Polymethyl methacrylates are to be understood as meaning in particular polymethyl methacrylate (PMMA) and copolymers based on methyl methacrylate with up to 40% by weight of further copolymerizable monomers, as obtainable, for example, under the names Lucryl® from BASF Aktiengesellschaft or Plexiglas® from Röhm GmbH. A copolymer of 98% by weight of methyl methacrylate and 2% by weight of methyl acrylate as a comonomer may be mentioned merely by way of example (Plexiglas® 8N, from Röhm). A copolymer of methyl methacrylate with styrene and maleic anhydride as comonomers is also suitable (Plexiglas® HW55, from Röhm).

Suitable polycarbonates are known per se. They are obtainable by interfacial polycondensation, for example by the processes of DE-B-1 300 266, or by reacting diphenyl carbonate with bisphenols according to the process of DE-A-14 95 730. A preferred bisphenol is 2,2-di(4-hydroxyphenyl)propane, generally referred to as bisphenol A.

Instead of bisphenol A, it is also possible to use other aromatic dihydroxy compounds, in particular 2,2-di(4-hydroxyphenyl)-pentane, 2,6-dihydroxynaphthalene, 4,4′-dihydroxydiphenyl sulfone, 4,4′-dihydroxydiphenyl ether, 4,4′-dihydroxydiphenyl sulfite, 4,4′-dihydroxydiphenylmethane, 1,1-di(4-hydroxyphenyl)-ethane or 4,4′-dihydroxybiphenyl or mixtures of the abovementioned dihydroxy compounds.

Particularly preferred polycarbonates are those based on bisphenol A or on bisphenol A together with up to 30 mol % of the abovementioned aromatic dihydroxy compounds.

Polycarbonates are obtainable, for example, under the trade names Makrolon® (from Bayer), Lexan® (from General Electric), Panlite® (from Tejin) or Calibre® (from Dow).

The relative viscosity of these polycarbonates is in general from 1.1 to 1.5, in particular from 1.28 to 1.4 (measured at 25° C. in a 0.5% strength by weight solution in dichloromethane).

Polybutylene terephthalate and polyethylene terephthalate are prepared as a rule in a manner known per se, by condensation of terephthalic acid or esters thereof with butanediol or ethanediol under catalysis. The condensation is advantageously carried out in two stages (precondensation and polycondensation). Details are to be found, for example, in Ullmann's Encyclopädie der Technischen Chemie, 4th Edition, Volume 19, pages 61-88. Polybutylene terephthalate is commercially available, for example, as Ultradur® (from BASF).

Preferred polyamides are very generally those having an aliphatic semicrystalline or partly aromatic and amorphous structure of any type, and blends thereof. Appropriate products are available, for example, under the trade name Ultramid® (from BASF).

Thermoplastic polyurethanes are usually prepared by reacting organic, preferably aromatic, diisocyanates, such as diphenylmethane 4,4′-diisocyanate, with polyhydroxy compounds which are preferably essentially linear, for example polyetherols, or polyesterols, such as polyalkylene glycol polyadipates, and diols acting as chain extenders, such as butane-1,4-diol, in the presence of catalysts, for example tertiary amines (such as triethylamine) or organic metal compounds.

The ratio of NCO groups of the diisocyanates to the sum of the OH groups (from the polyhydroxy compounds and chain-extending diols) is preferably about 1:1.

The preparation of the TPU is preferably carried out by the belt process in which the stated components and the catalyst are mixed continuously by means of a mixing head and the reaction mixture is applied to a conveyor belt. The belt passes through a zone heated to 60-200° C., the mixture undergoing reaction and solidifying.

Details of the TPU are to be found, for example, in EP-A 443 432. TPU are available, for example, under the trade name Elastollan® (from Elastogran).

Component C may furthermore essentially comprise copolymers of C₂-C₈-alkenes, such as ethylene, propene and butene with
vinylaromatics,
polar comonomers, such as acrylic acid and methacrylic acid, the C₁-C₁₀-alkyl esters of acrylic acid and of methacrylic acid,
other mono- or polyfunctional ethylenically unsaturated acids, such as maleic acid, maleic anhydride, fumaric acid, itaconic acid and esters thereof, in particular glycidyl esters, esters with C₁-C₈-alkanols and esters with aryl-substituted C₁-C₈-alkanols,
carbon monoxide,
nonaromatic vinyl compounds, such as vinyl acetate, vinyl propionate and vinyl alkyl ethers,
basic monomers, such as hydroxyethyl acrylate, dimethylaminoethyl acrylate, vinylcarbazole, vinylaniline, vinylcaprolactam, vinylpyrrolidone, vinylimidazole and vinylformamide,
acrylonitrile, methacrylonitrile,
   which are prepared in a generally known manner.

In a preferred embodiment, a polymer C which can be prepared from 40-75% by weight of ethylene, 5-20% by weight of carbon monoxide and 20-40% by weight of n-butyl acrylate is used (commercially available as Elvaloy® HP-4051 (from DuPont), or a polymer which can be prepared from 50-98.9% by weight of ethylene, 1-45% by weight of n-butyl acrylate and 0.1-20% by weight of one or more compounds selected from the group consisting of acrylic acid, methacrylic acid and maleic anhydride.

The preparation of the last-mentioned embodiments is usually carried out by free radical polymerization and is described in U.S. Pat. No. 2,897,183 and U.S. Pat. No. 5,057,593.

Copolymers of butadiene or substituted butadienes with styrene, methyl methacrylate or acrylonitrile are also suitable, for example nitrile rubber (NBR) or styrene/butadiene rubber (SBR). Some or all of the olefinic double bonds in these copolymers may have been hydrogenated.

Other suitable components C are butadiene/styrene copolymers which have block structures and are, where appropriate, hydrogenated or partially hydrogenated. They are preferably prepared by the method of anionic polymerization in solution using organometallic compounds, such as sec-butyllithium, linear block rubbers being formed, for example those having the structure styrene/butadiene (two-block) or styrene/butadiene/styrene (three-block). These blocks may be separated from one another by polymers having a random distribution, and furthermore the blocks may also contain minor amounts of units of the respective other monomers.

The presence of small amounts of an ether, in particular tetrahydrofuran (THF), in addition to the initiator, results in the formation of polymer chains which, starting from a butadiene-rich initial segment, have an increasing styrene content along the chain and finally end in a homopolystyrene terminal segment. Details of the preparation process are described in DE-A 31 06 959. Polymers C which have such a composition may be hydrogenated or partially hydrogenated are also suitable.

Other suitable components C are polymers having a star-like structure which are obtained by linking a plurality of polymer chains, mainly three-block polymers of the type styrene/butadiene/styrene, via polyfunctional molecules. Suitable linking agents are, for example, polyepoxides, for example epoxidated linseed oil, polyisocyanates, such as 1,2,4-triisocyanatobenzene, polyketones, such as 1,3,6-hexanetrione, and polyanhydrides, as well as dicarboxylic esters, such as diethyl adipate, and silicon halides, such as SiCl₄, metal halides, such as TiCl₄, and polyvinylaromatics, such as divinylbenzenes. Further details of the preparation of these polymers are to be found in, for example, DE-A 26 10 068.

In addition to the elastomer component A and polymers B and C, the molding materials prepared by the novel process may contain, as further component D, additives, for example waxes, plasticizers, lubricants and mold release agents, pigments, dyes, dulling agents, flameproofing agents, antioxidants, light stabilizers and heat stabilizers, fibrous and pulverulent fillers and reinforcing agents and antistatic agents in the usual amounts for these agents.

The additives D may be present in pure form and in the solid, liquid or gaseous state or may be used as a mixture of the pure substances with one another. They may also be used in a formulation which facilitates metering, for example as a solution or as a dispersion (emulsion or suspension). A formulation in the form of a masterbatch, ie. a concentrated mixture with a thermoplastic polymer compatible with the extruder content, is also suitable and is preferred in many cases.

The polymers C and the additives D can be fed to the extruder in one or more of the stated extruder sections. In a preferred embodiment, the components C and D are introduced into the extruder—separately from the elastomer component A and the thermoplastic polymer B—in vent section 1, in metering section 2 and/or in section 4 in which the polymer is fed to the extruder. In a further preferred embodiment, the components C and/or D are fed to the extruder in a further section 7.

The components C and D can be metered into the same section or sections or each into different extruder sections, and both 100% of C and 100% of D may be fed to the extruder in one section or distributed over a plurality of sections.

The exact embodiment of the feed of C and D depends on the stated physical and chemical properties of the components A to D and on their ratios. For example, it is possible for additives D having low heat resistance not to be fed to the extruder until the discharge zone, with the result that thermal degradation of the substances D is substantially prevented.

The thermoplastic molding materials prepared by the process can be processed by the generally conventional methods to give moldings. Examples are extrusion (for pipes, profiles, fibers, films and sheets), injection molding (for shaped articles of all kinds) and calendering and rolling (for sheets and films).

A substantial advantage of the apparatus of the invention and of the process of the invention is that there is substantially no discharge of fine particles from the extruder by way of the devolatilization orifices and/or dewatering orifices.

In addition, the apparatus of the invention is considerably simpler in technical terms than the known apparatuses.

Compared with the apparatuses known from the prior art, the apparatus of the invention has the further advantage that it permits substantially simpler operation, allowing very rapid cleaning and changeover.

### EXAMPLES

### Examples 1-3

The extruder used had the schematic structure given in table 1.

The feed comprised a polybutyl acrylate-g-SAN graft rubber with 38% residual moisture, which was extruded at 193.5 kg output rate. After the partial dewatering in zones 3 and 4, 65 kg/h of SAN melt were metered in in each of zones 6 and 10. The devolatilization orifice in zone 2 was sealed with the retention apparatus indicated under a-c. The shape of the retention apparatus corresponded to the curvature of the screw.

Zone 2 devolatilization orifice provided with

| | | | Operating |
|---|---|---|---|
| | Variant | Result | time |
| 1*) | a | fine crumbs are discharged | ++ |
| 2*) | b | practically no crumb discharge | −**) |
| 3 | c | no crumb discharge | ++ |

a) Seiher housing, 0.1 mm slot width
b) single-ply screen mesh, mesh width 250 μm
c) 5-ply metal-wire-mesh composite sheet, finest mesh on the inner side with mesh width 250 μm
*) for comparison
**) screen mechanically damaged after only a short period (about 12 min). Examples 4-8

The extruder used had the schematic structure given in table 1. The lateral devolatilization orifices were operated between zones 4 and 6, the final squeeze zone and the first melt-feed zone.

The feed comprised a polybutadiene-g-SAN graft rubber with 28% residual moisture. The rubber was partially dewatered and was in powder form. The temperature was about 150° C., and it was therefore possible for water to vaporize even before the mixing with SAN melt. The melt was added by way of zone 6, and where appropriate also by way of zone 10, so as to give a product with about 30% of rubber. The throughput rate of moist rubber was 125 kg/h in one formulation and 170 kg/h in another. The extruder rotation rate was 300 rpm.

TABLE 1
Example of schematic structure of a ZSK-58-sized twin-screw machine

| | | | In normal | | |
|---|---|---|---|---|---|
| | | | operation | | |
| Zone | Name | Apertures | provided with | Screw | Comments |
| 1 | Metering zone | Top | Weigh feeder | Conveying elements | |
| 2 | Devolatilization | Top/lateral | Retention | Conveying elements | Open if desired |
| | zone | | apparatus *) | | |
| 3 | 1st squeeze zone | Top | Retaining | Retarding elements, | |
| | | | screw | conveying elements | |
| 4 | 2nd squeeze zone | Top | Retaining | Retarding elements, | |
| | | | screw | conveying elements | |
| 5 | Devolatilization | Top/lateral | Retention | Conveying elements | Open if desired |
| | zone | | apparatus *) | | |
| 6 | 1st melt feed | Lateral | Ancillary | Conveying elements, | Introduction on SAN melt |
| | | | extruder | mixing elements | |
| 7 | Plastication zone | Sealed barrel | | Conveying elements, | |
| | | | | mixing elements | |
| 8 | Plastication zone | Sealed barrel | | Conveying elements, | |
| | | | | mixing elements | |
| 9 | Devolatilization | Top/lateral | Retention | Conveying elements | Open if desired |
| | zone | | apparatus *) | | |
| 10 | 2nd melt feed | Lateral | Ancillary | Conveying elements, | Option for 2nd melt, |
| | | | extruder | mixing elements | masterbatches, blend |
| | | | | | components |
| 11 | Devolatilization | Top | Retention | Conveying elements | |
| | | | apparatus *) | | |
| 12 | Discharge zone | Sealed barrel | | Conveying elements | |
| 13 | Discharge zone | Sealed barrel | | Conveying elements | |

*) according to the invention or according to the prior art

TABLE 2
Examples 4-8

| | Variant | Discharge: vapor | | | |
|---|---|---|---|---|---|
| | Covering of devolatilization | and escape of crumb at | | Operating | |
| Ex. No. | orifices | 125 kg/h | 170 kg/h | time | Comments |
| 4 *) | Single-ply screen mesh | 0 | — | — | mech. breakdown of screen |
| 5 *) | Corotating retaining screws | ++ | +++ | ++ | |
| 6 *) | Counterrotating retaining screws | + | ++ | ++ | |
| 7 *) | Seiher housing, 0.1 mm slot width | + | ++ | + | has to be cleaned after 2 h |
| 8 | 5-ply metal-screen composite | 0 | 0 | ++ | no blocking after 8 h |
| | sheet | | | | no blocking on restart |

*) for comparison

### Example 9 and 10

The extruder used had the schematic structure given in table 1. There was a devolatilization orifice in zone 9 after the first melt feed and the plastication zone. 152 kg/h of a polybutyl acrylate-g-SAN graft rubber with residual moisture of 28% were fed into the metering zone. This was partially dewatered in the squeeze zones. 140 kg/h of SAN were metered into zone 6.

| | Devolatilization orifice | Vaopr discharge and escape |
|---|---|---|
| Ex. No. | provided with | of crumb |
| 9 | corotating retaining screws | + |
| 10 | retention apparatus of the invention | 0 |
| 11 | open | ++ |

*) for comparison

Definition
0=no escape of crumb
+=slight escape of crumb
++=marked escape of crumb
+++=very severe escape of crumb
   Operating Time
− Experiment had to be terminated due to mechanical defect
+ Cleaning needed during the experiment
++ No adverse effects occured at any time during the experiment

1. An apparatus intended for extruding thermoplastics and comprising at least one metering section, one plastication section, one devolatization orifice, which is a cut-out or hole in the extruder barrel, and also one discharge zone, wherein a metal-wire-mesh composite sheet, a finely perforated metal sheet with perforation widths of from 0.06 to 4 mm, or a slit diaphragm has been secured within at least one devolatization orifice.

2. An apparatus as claimed in claim 1, which has at least one dewatering orifice, some or all of the water discharged from which is discharged in the liquid phase.

3. An apparatus as claimed in claim 1, which has, in the upstream direction, prior to a first metering means in a direction opposed to the conveying direction, at least one dewatering orifice which has been equipped with a metal-wire-mesh composite sheet, with a finely perforated metal sheet, or with a slit diaphragm.

4. An apparatus as claimed in claim 1, which has, in the downstream direction, after a first metering means in the conveying direction, at least one dewatering orifice which has been equipped with a metal-wire-mesh composite sheet, with a finely perforated metal sheet, or with a slit diaphragm.

5. An apparatus as claimed in claim 1, wherein the metal-wire-mesh composite sheet, the finely perforated metal sheet, or the slit diaphragm has been introduced into a frame, which has been attached to the relevant devolatilization orifices or dewatering orifices by means of a cramp.

6. An apparatus as claimed in claim 1, wherein the metal-wire-mesh composite sheet, the finely perforated metal sheet, or the slit diaphragm has been attached to the relevant orifice by means of a hinge or by means of a quarter-turn fastener.

7. An apparatus as claimed in claim 1, wherein use is made of a metal-wire-mesh composite sheet.

8. An apparatus as claimed in claim 1, wherein the extruder used has at least two corotating or counterrotating screws, the extruder being substantially composed of the following in the conveying direction (the downstream direction)
at least one metering section through which, by way of a metering means, a thermoplastic comprising water or comprising another vaporizable liquid is introduced into the extruder, the metering section encompassing, if desired, at least one dewatering orifice which has been equipped, if desired, with a metal-wire-mesh composite sheet, with a finely perforated metal sheet, or with a slit diaphragm,
if desired, at least one squeeze section which serves for dewatering the thermoplastic and comprises at least one retarding element, and also in each case at least one associated dewatering orifice, where the latter has been equipped, if desired, with a metal-wire-mesh composite sheet, with a finely perforated sheet, or with a slit diaphragm,
if desired, at least one feed section in which further thermoplastic is introduced as melt into the extruder,
at least one plastication section provided with mixing, kneading, and/or other plastication elements,
at least one devolatilization section which has at least one devolatilization orifice and in which the remaining water is removed as vapor, where at least one of the devolatilization orifices has been equipped with a metal-wire-mesh composite sheet, with a finely perforated metal sheet, or with a slit diaphragm, and
a discharge zone (VI).

9. An apparatus as claimed in claim 1, wherein the extruder used is one with at least one feed section.

10. An apparatus as claimed in claim 9, wherein the extruder used is one which has at least one devolatilization section arranged prior to the first feed section.

11. An apparatus as claimed in claim 10, wherein the extruder used is one which has at least one devolatilization section which follows the final plastication section.

12. A process for preparing thermoplastics in an extruder with devolatilization, which comprises introducing a thermoplastic to an apparatus as claimed in claim 1, devolatilizing it in the apparatus, and then discharging it.

13. A process as claimed in claim 12, wherein a thermoplastic is prepared from a water-moist component comprising up to 90% by weight of residual water, by introducing this component into the apparatus as claimed in at least one of claims 1 to 11 and, if desired, mixing it with other components, with devolatilization and dewatering, and then discharging the thermoplastic.

14. A process as claimed in claim 12, wherein toughened thermoplastics or polymer blends comprising toughened thermoplastics are prepared.

15. (canceled)

16. (canceled)

17. A method for preparing toughened thermoplastics or polymer blends comprising toughening thermoplastics with the apparatus as claimed in claim 1.

18. A method for extruding thermoplastics comprising using a metal-wire-mesh composite sheet, of a finely perforated metal sheet with perforation widths of from 0.06 to 4 mm, and/or of a slit diaphragm for the covering of devolatilization orifices and/or dewatering orifices in an apparatus.
